(19) United States
(12) Patent Application Publication
(10) Pub. No.: US 2023/0260337 A1
(43) Pub. Date: Aug. 17, 2023

(54) CONFIGURABLE STATUS CONSOLE WITHIN AN AIRCRAFT ENVIRONMENT AND METHOD

(71) Applicant: GE Aviation Systems LLC, Grand Rapids, MI (US)

(72) Inventors: Michael A. Viola, Grand Rapids, MI (US); Tyler M. Leamon, Grand Rapids, MI (US)

(73) Assignee: GE Aviation Systems LLC, Grand Rapids, MI (US)

(21) Appl. No.: 17/674,581

(22) Filed: Feb. 17, 2022

(51) Int. Cl. G07C 5/08; G07C 5/00; B64F 5/60

(52) U.S. Cl. CPC G07C 5/0808; B64F 5/60; G07C 5/008; G07C 5/0825; H04L 67/12

(57) ABSTRACT

Provided is a method and a configurable status console for an aircraft verification and integration system (VAIS) of an aircraft network of an aircraft implemented within a computer system having one or more processors, the configurable status console via a processor performs an on-going scanning operation of the aircraft network and a simulation network in communication with the aircraft network, retrieves data that includes performance data, VAIS parameters and messaging data in real-time from the aircraft network and the simulation network, to determine the health of the aircraft, and analyzes the data and configures the status of the aircraft or components or simulation thereof and generates a configured status for the aircraft or components or simulation thereof to be displayed at the configurable status console.

### I. TECHNICAL FIELD

The technical field relates generally to a configurable status console. In particularly, a configurable status console performing a method that allows at-a-glance verification of the functionality of various systems within an aircraft environment.

### II. BACKGROUND

An aircraft has a system integration bench that is fairly complex and used for integration and verification of aircraft systems comprising multiple control panels, displays, and other systems such as a flight reconfiguration system (FRS) and onboard maintenance system (OMS) and other simulated LRUs. These components and systems thereof are critical to flight operations and require status updating and maintenance when necessary. Aircraft systems typically interface with health monitoring systems to run diagnosis and determine the health of an aircraft network and its components. However, conventional health monitoring systems are not connected to the simulation or test platform and are not configurable for different aircraft networks and simulation/test system interfaces.

It is desirable to have a configurable status console for providing, at a quick glance, a status of the aircraft’s system integration and verification bench (SIVB) computer hardware and software and simulation as well as that of integrated modular avionics (IMA) architectures, FRS, and OMS hardware.

### III. DESCRIPTION OF THE DRAWINGS

FIG. 1 is a block diagram illustrating an aircraft network environment in communication with a configurable status console according to one or more exemplary embodiments.

FIGS. 2A and 2B are flow charts illustrating a method performed via the configurable status console of FIG. 1 according to one or more exemplary embodiments.

FIG. 3 is an example of the configuration status console of FIG. 1 according to one or more exemplary embodiments.

FIG. 4 is a block diagram illustrating a computing system for displaying the status console of FIG. 1 and implementing the method of FIG. 2 according to one or more exemplary embodiments.

The drawings are only for purposes of illustrating preferred embodiments and are not to be construed as limiting the disclosure. Given the following enabling description of the drawings, the novel aspects of the presently described technology should become evident to a person of ordinary skill in the art. This detailed description uses numerical and letter designations to refer to features in the drawings. Like or similar designations in the drawings and description have been used to refer to like or similar parts of embodiments of the presently described technology.

### IV. DETAILED DESCRIPTION OF THE EMBODIMENTS

As required, detailed embodiments are disclosed herein. It must be understood that the disclosed embodiments are merely exemplary of various and alternative forms. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods that are known to those having ordinary skill in the art have not been described in detail in order to avoid obscuring the present disclosure. Therefore, specific structural and functional details disclosed herein are not to be interpreted as limiting, but merely as a basis for the claims and as a representative basis for teaching one skilled in the art.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

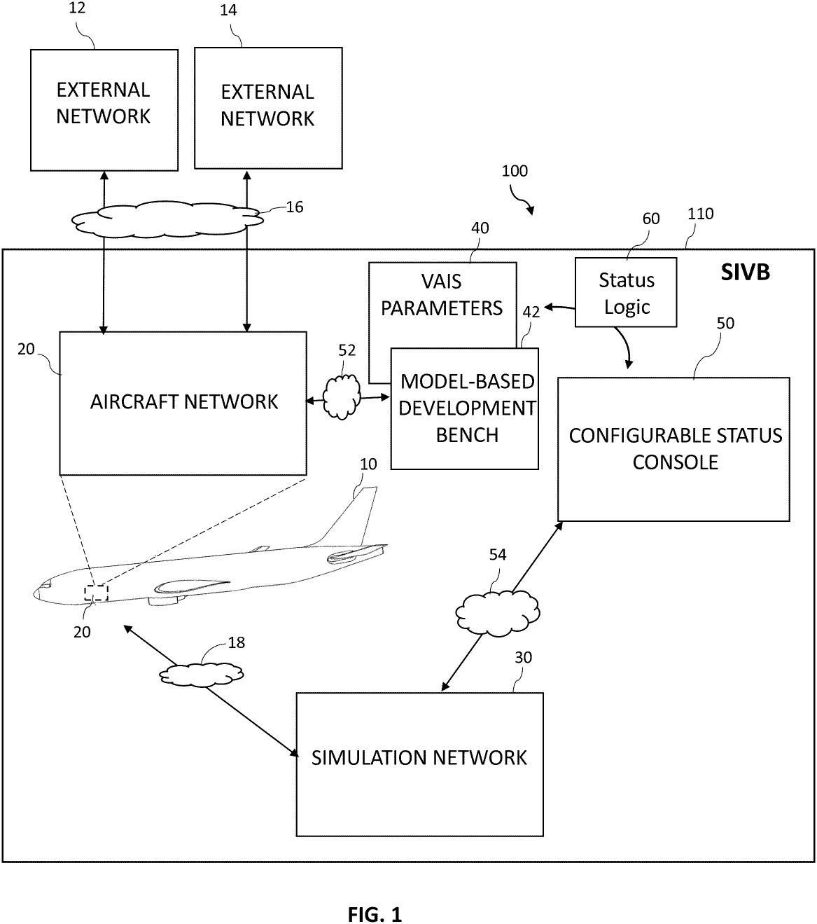

FIG. 1 is a block diagram illustrating an aircraft network environment in communication with a configurable status console for a system integration and verification bench (SIVB) 110 of an aircraft, according to the presently described technology.

As shown in FIG. 1 the aircraft network environment 100 is provided. The environment 100 includes the SIVB 110, an aircraft 10 comprising at least one aircraft (AC) network 20, a plurality of external networks 12 and 14, a simulation network 30, a configurable status console 50 and status logic 60 to facilitate configuration of the status console 50 according to embodiments.

The AC network 20 handles aircraft network traffic interconnecting computer systems of an aircraft 10. It includes several nodes in communication with one another. These nodes can include for example, sensors, actuators, control devices, and line replaceable unit (LRUs) such as a proximity detector, control panel, motor controller, and different types of monitoring devices. The aircraft 10 can have any number of individual or interconnected networks as required for the particular aircraft 10 and its systems. In addition, aircraft 10 can be any type of aircraft. The AC network 20 communicates with a plurality of external networks 12 and 14, for example, the airport ground stations, satellites, etc., and the simulation network 30 via wireless communication networks 16 and 18. The communication networks 16 and 18 can be one or more different communication networks including Ethernet, Wi-Fi and any other suitable communication networks.

The simulation network 30 can include a virtual aircraft integration system (VAIS) configured to perform real-time aircraft simulation for simultaneous testing of multiple aircraft systems, while communicating with the AC network 20.

According to embodiments, the AC network 20 includes network message structures such as ARINC 664, ARINC 825 and ARINC 429 network message structures and their coded parameters such as flight plan, waypoint information, maintenance commands, et al. The simulation network 30 includes the status of simulation models and simulated aircraft network parameters such as air temperature, air pressure, wind speed, et al.

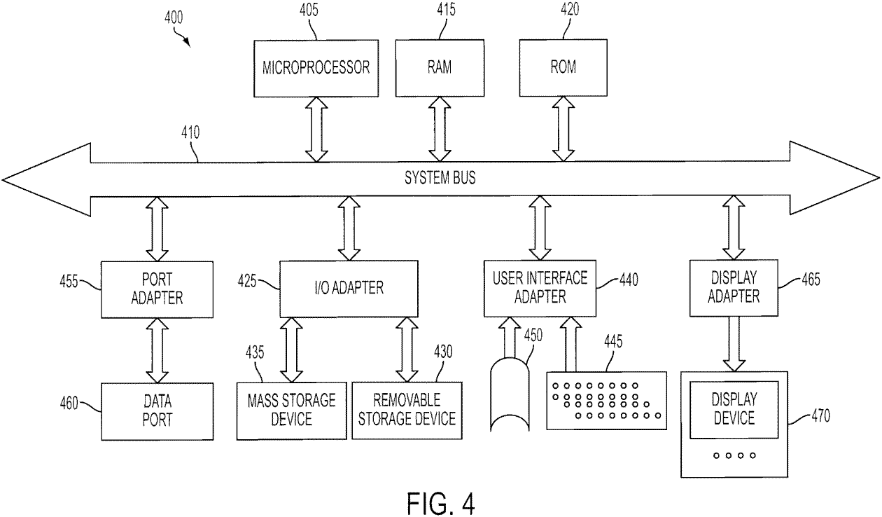

According to an embodiment, the configurable status console 50 is located within a computer system 400 (as depicted in FIG. 4) in a system integration laboratory (SIL) in a remote location and provides simulation, integration and verification users (e.g., technicians and engineers) a quick, glance verification of aircraft system requirements and testing. The configurable status console 50 uses the information from both the AC network 20 and the simulation network 30 to enable users to assess the overall health of the SIVB at a glance without having to perform troubleshooting.

The status console 50, via a processor (e.g., processor 405 as depicted in FIG. 4) is configured to continuously retrieve performance data in real-time from the AC network 20 and the simulation network 30 via communication networks 52 and 54 to determine the overall health of the aircraft 10 using IP data, VAIS and Virtual Aircraft Simulation Toolsets (VAST) parameters 40 and aircraft-configured message information (e.g., A664 messages) approximately every second, for example to determine an actual rate of the messaging data for comparison to an expected rate. The status console 50 via the computer system 400 is in wired or wireless communication with flight test interfaces via the simulation network 30. The performance data retrieved can include, for example, computer networks and IP systems data, aircraft usage data including flight control data, fuel data, pressure and temperature data and aircraft operations data. The status console 50 is configured to tap into the flight test interfaces or other aircraft network (e.g., AC network 20) ports to gather necessary data as well as monitor simulation network traffic through wired network interfaces.

The status console 50, via the processor 405 retrieves the performance data, simulation parameters (i.e., VAIS/VAST parameters 40), and message information including message statuses and flight messages in real-time and continuously from the AC network 20 and the simulation network 30 via a model-based development workbench (MBD) 42 also located within the SIVB 110 of the aircraft environment 100. The VAIS and MBD configurations include code information (e.g., in a database) to be used by the status console 50, via the status logic 60 to decode the message structures of the AC network 20, allowing the status console 50 to determine which parameters are available on the AC network 20 and the simulation network 30 at a given location and time. In an example network message that includes “23 a6 00 ff ac a2 00 08 40 51” it can be decoded to as message number=255 having a temperature value = 45° C. and validity = “valid” confirming it’s validity. The status console 50 is then able to be configured based on system-specific status information of an aircraft 10, its systems or other components of the AC network 20 or the simulation network 40 at an external computing device (e.g., the computing system 400 depicted in FIG. 4) for performing verification of the operational status of onboard aircraft systems and simulations within the aircraft environment 100 as shown in FIG. 1.

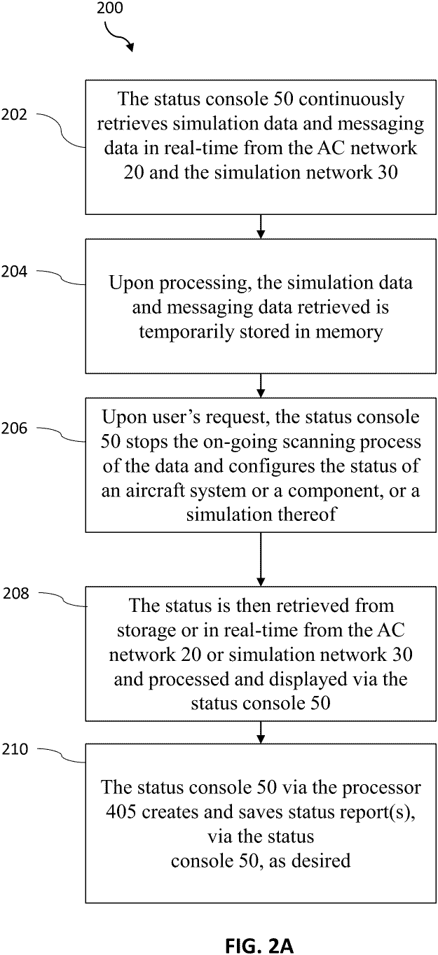

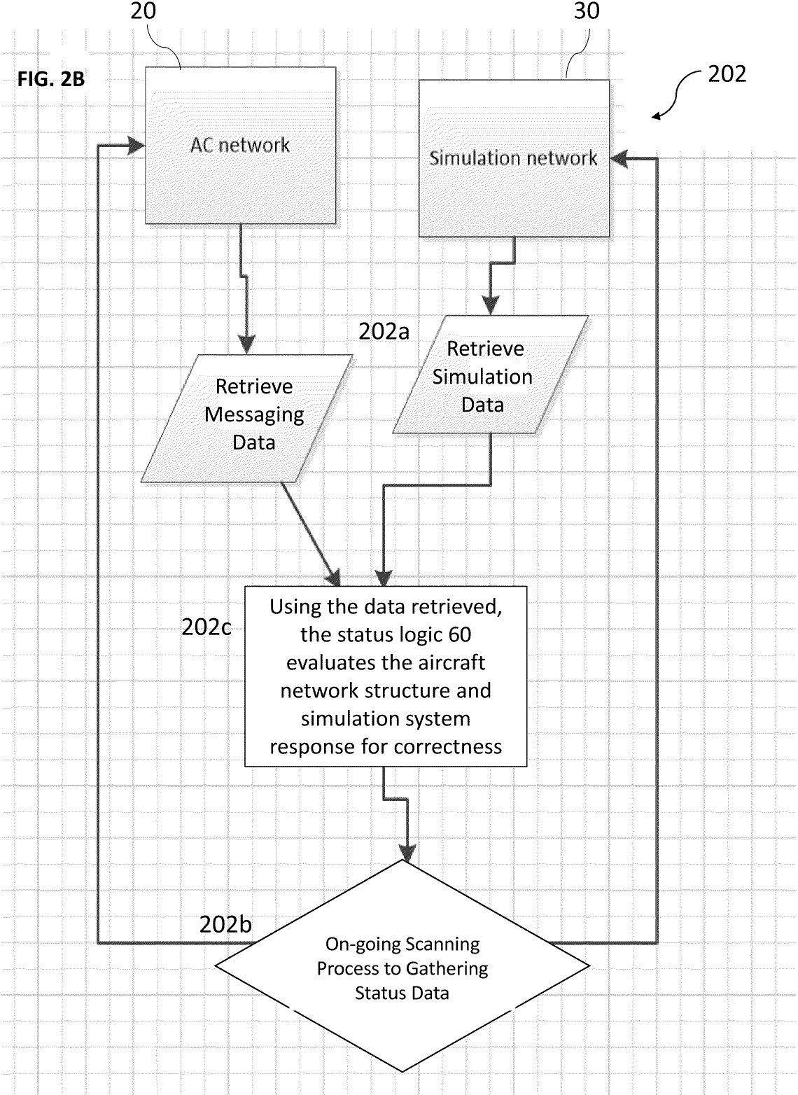

Additional details regarding the method for performing configuration of the configurable status console 50 will be described below with reference to FIGS. 2A and 2B.

FIGS. 2A & 2B are flow charts illustrating a method 200 and operations thereof performed via the configurable status console 50 of FIG. 1 according to one or more exemplary embodiments. The method begins at operation 202, the status console 50 continuously retrieves simulation data and messaging data at operation 202a of FIG. 2B in real-time from the AC network 20 and the simulation network 30, approximately every second in an on-going scanning process at operation 202b that is running on the backend and configurable based on system needs. Status logic 60 is implemented therein at operation 202c to evaluate the aircraft network structure and simulation system response for correctness. Status logic 60 uses aircraft specific decision criteria to process the data received such as checking the aircraft flight test interface for a periodic monitor message receive rate from the AC network 20, wherein if the receive rate is increasing, the avionics status is reflected as “green” in color as well as simulation specific performance measures such as checking the simulation computers network interface from the simulation network 30 for dropped frames. If a dropped frames rate is greater than an allowed limit, then the simulation computer status is reflected as “red” in color, to thereby provide the user with a “go”, green, “no-go”, red, status indication on the status console 50. According to embodiments, the aircraft specific decision criteria may vary based on the desired status data.

According to embodiments, at operation 202c, the status logic 60 performs the troubleshooting and verification operations of the aircraft systems. The troubleshooting and verification operations can include for example, actual AC network message rates not matching expected or configured network rates, AC system data out of range, simulation network interface errors, AC system network interface errors, simulated AC system software/hardware configuration part numbers mismatch to actual part number.

The status logic 60 can perform troubleshooting and verification operations on analog parameters such as voltage, current frequency, pressure and temperature of the aircraft systems and discrete counting parameters for example, using sliding window algorithms, and trending algorithms e.g., moving average, to determine if a status of a parameter is trending from good to bad to status change from bad to good at an instantaneous maximum or minimum level. This allows the parameter status to be updated before some event happens that may cause hardware issues or require testing to be re-run.

In operation, for example, the aircraft computers may be installed in the aircraft with induced cooling or in a test lab with passive cooling at a temperature range of 42° C. to 47° C. For each aircraft passively cooled avionic unit, the status logic 60 tracks any deviation from the average temperature. For example, the status logic 60 implements an algorithm, e.g., a sliding window algorithm to track the last ten (10) temperature samples. If the temperature samples are all around 45° C. then the sliding window average deviation would be zero (0). If the samples range from 45.01° C. to 46.06° C. and so on then the average deviation would go from zero (O) to 0.32 and so on. The status logic 60 can be configured to allow a threshold the average deviation of no more than 0.5, for example. In this case the status logic 60 would be checking the temperature change rate, wherein if temperature change rate is less than an allowable limit (e.g., the average deviation threshold), then the status logic 60 would trigger the status console 50 to set the unit temperature status to green; otherwise, the status logic 60 will trigger the status console 50 to set the unit temperature status to “red”. For each aircraft avionic unit, the status logic 60 also checks the actual latency of periodic monitor message versus required latency, and, if actual latency is less than the required latency, then the status logic 60 sets the unit latency to “green”; otherwise, the status logic 60 sets the unit latency to “red”.

For each simulation model at the simulation network 30, delivery of the data at specified rates is imperative, for example, a simulation model of the atmosphere can be configured to send data at 80 hertz (hz). If so, then a message from the respective simulation model occurs on the simulation network 30 every 125 milliseconds (ms). The status logic 60 is configured to monitor the actual latency or time between periodic monitor messages (e.g., the last 3 messages) versus a required latency or time, and, if the time (e.g., average time thereof) is less than e.g., 5 ms from the predetermined rate of 125 ms for 3 consecutive messages, the status logic 60 will trigger the status console 50 to set the status of the monitor for the simulation model of the atmosphere to green and if its greater than 5 ms for example, then the status logic 60 will trigger the status console 50 to change the status of the monitor from green to red. If model messages are transmitted every 125 ms then the average difference from the expected latency would be zero (0). On the other hand, if the messages are coming in at varied times, for example, 126 ms, 128 ms, 130 ms, 128 ms, 130 ms 125, 142 ms, 125 ms, 125 ms and then the average latency would go from 0 to 0.33, 1.33, 3, 3.67, 4.33, 2.67, 7.33, 5.67, and 5.67. Since the last 3 values are over 5 ms the actual latency (e.g., average thereof) is greater than the required latency, then the status logic 60 triggers the status console 50 to change the unit latency of the monitor for the simulation model of the atmosphere from “green” to “red” thus notifying the operators that the simulation models could be invalid; otherwise, the status logic 60 maintains the unit latency status at “green”. For each simulation computer resource, the status logic 60 checks the network interface of simulation network, and, if echo round-trip time is less than 500 milliseconds (ms), then the status logic 60 sets the simulation computer resource network status to “green”; otherwise, the status logic 60 sets the simulation computer resource network status to “red”.

Referring back to FIG. 2A, from operation 202, the process continues to operation 204, upon processing the simulation data and messaging data retrieved is temporarily stored memory (e.g., RAM 415 depicted in FIG. 4). According to embodiments, since the simulation data and messaging data dynamically change in real-time; the status data at the status console 50 resulting therefrom dynamically changes in real-time as described above. From operation 204, the process continues to operation 206, where at a user’s request at the status console 50, the status console stops the on-going scanning process and configures the status of an aircraft system or a component, or a simulation thereof at the status console 50. The status logic 60 can continuously perform the on-going scanning process unless it receives instructions to stop the scanning process. From operation 208, the status is then retrieved from storage or in real-time from the AC network 20 or simulation network 50 and processed and displayed via the status console 50. From operation 208 to operation 210, upon user request, the processor 405 creates and saves status report(s) of different devices, to be output at the status console 50, as specified by the user.

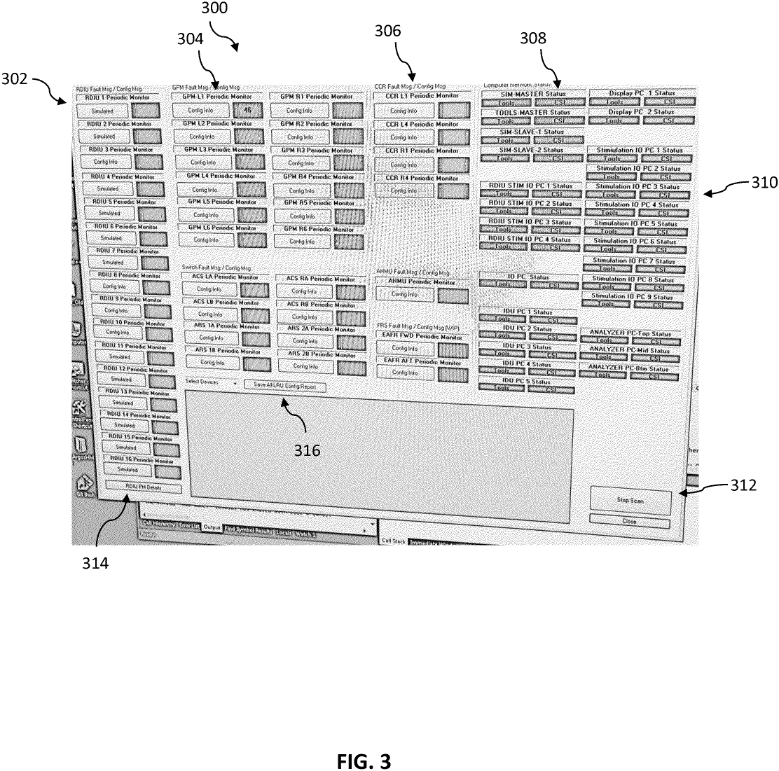

FIG. 3 is an example configurable status console 300 performing the method 200 of FIG. 2. The status console 300 includes a plurality of inputs (e.g., buttons) 302, 304, 306, 308 and 310 corresponding to the various data systems, computing systems, displays, and simulation systems within the aircraft environment 100 of FIG. 1. The data systems includes various systems such as for example, remote data interface unit (RDIU) 1-16 periodic monitor, general processing module (GPM) L1-L6 periodic monitor, general processing module (GPM) R1-R6 periodic monitor, avionics full duplexed switched ethernet (AFDX) Cabinet Switch (ACS) LA, LB, 1A, 1B, RA, RB periodic monitor and AFDX Remote Switch (ARS) 2A, 2B periodic monitor, CCR L1, L4 and R1, R4 periodic monitor, AHMU periodic monitor, FRS fault msg/config EAFR FWD & AFT periodic monitors. The computer systems include computer network statuses for various computers in the AC network 20 including for example, subscriber identity module (SIM)- master and slave 1 & 2, tools master, RDIU STIM OI PC 1-4, IO PC status monitor, IDU PC 1-5, Display PC 1 & 2, Simulation IO PC 1-9, analyzer PC-top, PC-mid, and PC-btm. The computer system, for example, computing system 400 (as depicted in FIG. 4) uses VAIS and MBD configuration data based on AC network 20 configuration to decode the parameters via network message structures, for example, ARINC 664, ARINC 825 and ARINC 429 network message structures. The computer system uses periodic monitoring of these parameters and aircraft specific logic to determine the current status of both simulation and aircraft systems from the AC network 20 and the simulation network 30. The status of the systems and displays is displayed, for example, using colors to indicate the status. For example, green is indicative of good while red is indicative of an existing issue, and additional information may be displayed as well, such as temperature of hardware. A user is able to stop the on-going scanning process at an input 312 currently being performed and configure a status for a specific device or system. The RDIU periodic monitor (PM) details can also be viewed at input 314. The PM data contains system health data and may include continuously changing built-in test results. A configured status report can be generated at input 316 and may include the health data corresponding to AC system configuration data such as SW/HW part numbers and network configuration part numbers.

FIG. 4 is a block diagram illustrating a computing system 400 for displaying the status console 50, 300 of FIGS. 1 and 3, and for implementing the method 200 of FIG. 2 according to one or more exemplary embodiments.

The computing system 400 includes at least one microprocessor or central processor (CPU) 405. The CPU 405 is interconnected via a system bus 410 to a random access memory (RAM) 415, a read-only memory (ROM) 420, an input/output (I/O) adapter 425 for connecting a removable data and/or program storage device 430 and a mass data and/or program storage device 435, a user interface adapter 440 for connecting a keyboard 445 and a mouse 450, a port adapter 455 for connecting a data port 460 and a display adapter 465 for connecting a display device 470.

The ROM 420 contains the basic operating system for the computer system 400. The operating system may alternatively reside in the RAM 415 or elsewhere as is known in the art. Examples or removable data and/or program storage device 430 include magnetic media such as floppy drives and tape drives and optical media such as CD ROM drives. Examples of mass data and/or program storage device 435 include hard disk drives and non-volatile memory such as flash memory. In addition to the keyboard 445 and the mouse 450, other user input devices such as trackballs, writing tablets, pressure pads, microphones, light pens, and position sensing screen displays may be connected to user the user interface adapter 440. Examples of display devices include cathode-ray tubes (CRT) and liquid crystal displays (LCD).

A computer program with an appropriate application interface may be created by one of skill in the art and stored on the system or a data and/or program storage device to simplify the practicing of the presently described technology. In operation, information for or the computer program created to run the presently described technology is loaded on the appropriate removable data and/or program storage device 430, fed through data port 460 or typed in using the keyboard 445. In view of the above, the present method embodiment may therefore take the form of a computer or controller implemented processes and apparatuses for practicing those processes. This disclosure can also be embodied in the form of computer program code containing instructions embodied in tangible media, such as floppy diskettes, CD ROMs, hard drives, or any other computer-readable storage medium, wherein, when the computer program code is loaded into and executed by a computer or controller, the computer becomes an apparatus for practicing the presently described technology. This disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the presently described technology. When implemented on a general-purpose microprocessor, the computer program code segments configure the microprocessor to create specific logic circuits. Conventionally, aircraft systems typically interface with health monitoring systems for performing system troubleshooting to determine the health of an aircraft network and its components. However, they are not connected to a simulation or test platform and therefore are not configurable for different aircraft networks and simulation/test system interfaces. Some technical effects of the executable instructions are that by implementing the exemplary method 200 described above, system troubleshooting time can be minimized when attempting to identify issues with the aircraft’s system integration and verification bench (SIVB), and incorporation of simulation/test data can provide a more accurate status update of the aircraft systems.

The configurable status console and the method performed according to the presently described technology, enables verification of real-time operational statuses of an aircraft system, its components and simulation thereof, at a quick glance by users without having to perform troubleshooting.

Example 1 is a configurable status console for an aircraft verification and integration system (VAIS) of an aircraft network of an aircraft implemented within a computer system having one or more processors is provided. The configurable status console via a processor performs an on-going scanning operation of the aircraft network and a simulation network in communication with the aircraft network; retrieves data including performance data, VAIS parameters and messaging data in real-time from the aircraft network and the simulation network, to determine the health of the aircraft; and using status logic, analyzes the data and configures a status of at least one of the aircraft or components or simulation thereof and generates a configured status for the at least one aircraft or components or simulation thereof to be displayed at the configurable status console.

The configurable status console of the preceding clause wherein, the configurable status console via the processor is further continuously retrieves the performance data, the VAIS parameters and the messaging data in real-time from the aircraft network and the simulation network, to determine the health of the aircraft.

The configurable status console of any one of the preceding clause wherein, the messaging data includes aircraft-configured message information.

The configurable status console of any one of the preceding clause wherein the messaging data is also retrieved approximately every second to determine an actual rate of the messaging data for comparison to an expected rate.

The configurable status console of any one of the preceding clause wherein the configurable status console is in wireless communication with the aircraft network and the simulation network.

The configurable status console of any one of the preceding clause wherein the above-mentioned performance data includes computer networks and IP systems data, aircraft usage data including flight control data, fuel data, pressure and temperature data and aircraft operations data.

The configurable status console of any one of the preceding clause wherein the configurable status console also initiates a stop of the on-going scanning operation upon request, and generates the configured status for the at least one aircraft or components or simulation thereof;

The configurable status console of any one of the preceding clause wherein the above-mentioned VAIS parameters comprise ARINC 664, ARINC 825 and ARINC 429 network message structure and data characteristics for simulated aircraft information.

The configurable status console of any one of the preceding clause wherein the performance data, VAIS parameters and messaging data dynamically change such that the configured status dynamically changes at the configurable status console.

The configurable status console of any one of the preceding clause wherein the configurable status console also decodes the VAIS parameters and messaging data of the aircraft network to determine parameters available on the aircraft network and the simulation network at a given location and time, to thereby configure system-specific status information of an aircraft or the simulation network.

The configurable status console of any one of the preceding clause wherein the configurable status console implements the status logic, via the processor, to evaluate the aircraft network and the simulation network, wherein the status logic includes using aircraft specific decision criteria to determine a status of the aircraft network and simulation network.

The configurable status console of any one of the preceding clause wherein the aircraft specific decision criteria includes checking aircraft test interfaces for periodic monitor message receive rate, checking simulation network interfaces for dropped frames, checking a temperature rate change of aircraft systems, checking latency of periodic monitor messages from the aircraft network and the simulation network.

Example 2 is a method performed by a configurable status console for an aircraft verification and integration system (VAIS) of an aircraft network of an aircraft implemented within a computer system via a processor is provided. The method includes performing an on-going scanning operation of the aircraft network and a simulation network in communication with the aircraft network, retrieving performance data, VAIS parameters and messaging data in real-time from the aircraft network and the simulation network, to determine the health of the aircraft, and analyzing the data and configuring a status of at least one aircraft, or components or simulation thereof and generating a configured status for the at least one aircraft or components or simulation thereof, and displaying the configured status.

The method of the preceding clause wherein the method further includes continuously retrieving the performance data, the VAIS parameters and the message data in real-time from the aircraft network and the simulation network to determine the health of the aircraft.

The method of any one of the preceding clauses wherein the method further includes dynamically changing of the configured status at the configurable status console based on the dynamically changing of the performance data, VAIS parameters and messaging data.

The method of any one of the preceding clauses wherein the method further includes decoding the VAIS parameters and messaging data of the aircraft network to determine parameters available on the aircraft network and the simulation network at a given location and time, thereby configuring system-specific status information of an aircraft or the simulation network.

The method of any one of the preceding clauses wherein the method further includes implementing the status logic via the processor, to evaluate the aircraft network and the simulation network, wherein the status logic includes using aircraft specific decision criteria to determine a status of the aircraft network and simulation network.

Example 3 is a computer-readable, non-transitory storage medium storing instructions that, when executed by a processor, cause the processor to perform a method by a configurable status console for an aircraft verification and integration system (VAIS) of an aircraft network of an aircraft is provided. The method includes performing an on-going scanning operation of the aircraft network and a simulation network in communication with the aircraft network, retrieving performance data, VAIS parameters and messaging data in real-time from the aircraft network and the simulation network, to determine the health of the aircraft, using status logic analyze the data and configuring a status of the at least one aircraft or components or simulation thereof, and generating a configured status for the at least one aircraft or components or simulation thereof to be displayed at the configurable status console.

The computer-readable, non-transitory storage medium of the preceding clause wherein the method further includes continuously retrieving the performance data, the VAIS parameters and the message data in real-time from the aircraft network and the simulation network to determine the health of the aircraft.

The computer-readable, non-transitory storage medium of the preceding clause wherein the method further includes implementing the status logic via the processor, to evaluate the aircraft network and the simulation network, wherein the status logic includes using aircraft specific decision criteria to determine a status of the aircraft network and simulation network.

This written description uses examples to disclose the presently described technology, including the best mode, and also to enable any person skilled in the art to practice the presently described technology, including making and using any devices or systems and performing any incorporated methods.

The patentable scope of the presently described technology is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A configurable status console for an aircraft verification and integration system (VAIS) of an aircraft network of an aircraft implemented within a computer system having one or more processors, the configurable status console via a processor is configured to:
perform an on-going scanning operation of the aircraft network and a simulation network in communication with the aircraft network;
retrieve data including performance data, VAIS parameters and messaging data in real-time from the aircraft network and the simulation network, to determine the health of the aircraft; and
using status logic, analyze the data and configure a status of at least one aircraft or components or simulation thereof and generate a configured status for the at least one aircraft or components or simulation thereof to be displayed at the configurable status console.

2. The configurable status console of claim 1, wherein the configurable status console via the processor, is further configured to continuously retrieve the performance data, the VAIS parameters and the messaging data in real-time from the aircraft network and the simulation network, to determine the health of the aircraft.

3. The configurable status console of claim 1, wherein the messaging data includes aircraft-configured message information.

4. The configurable status console of claim 3, wherein the messaging data is retrieved approximately every second to determine an actual rate of the message data for comparison to an expected rate.

5. The configurable status console of claim 1, wherein the configurable status console is in wireless communication with the aircraft network and the simulation network.

6. The configurable status console of claim 1, wherein the performance data comprises computer networks and IP systems data, aircraft usage data including flight control data, fuel data, pressure and temperature data and aircraft operations data.

7. The configurable status console of claim 1, wherein the configurable status console is further configured to initiate a stop of the on-going scanning operation upon request, and generate the configured status for the at least one aircraft or components or simulation thereof.

8. The configurable status console of claim 1, wherein the VAIS parameters comprise ARINC 664, ARINC 825 and ARINC 429 network message structure and data characteristics for simulated aircraft information.

9. The configurable status console of claim 8, wherein the performance data, VAIS parameters and messaging data dynamically change such that the configured status dynamically changes at the configurable status console.

10. The configurable status console of claim 9, wherein the configurable status console is further configured to decode the VAIS parameters and messaging data of the aircraft network to determine parameters available on the aircraft network and the simulation network at a given location and time, to thereby configure system-specific status information of an aircraft or the simulation network.

11. The configurable status console of claim 10, wherein the configurable status console implements the status logic, via the processor, to evaluate the aircraft network and the simulation network, wherein the status logic includes using aircraft specific decision criteria to determine a status of the aircraft network and simulation network.

12. The configurable status console of claim 11, wherein the aircraft specific decision criteria comprises checking aircraft test interfaces for periodic monitor message receive rate, checking simulation network interfaces for dropped frames, checking a temperature rate change of aircraft systems, checking latency of periodic monitor messages from the aircraft network and the simulation network.

13. A method performed by a configurable status console for an aircraft verification and integration system (VAIS) of an aircraft network of an aircraft implemented within a computer system via a processor, the method comprising:
performing an on-going scanning operation of the aircraft network and a simulation network in communication with the aircraft network;
retrieving data including performance data, VAIS parameters and messaging data in real-time from the aircraft network and the simulation network, to determine the health of the aircraft; and
using status logic, analyzing the data and configuring a status of at least one aircraft or components or simulation thereof, and generating a configured status for the at least one aircraft or components or simulation thereof to be displayed at the configurable status console.

14. The method of claim 13, wherein retrieving comprises continuously retrieving the performance data, the VAIS parameters and the message data in real-time from the aircraft network and the simulation network to determine the health of the aircraft.

15. The method of claim 13, further comprising:
dynamically changing of the configured status at the configurable status console based on the dynamically changing of the performance data, VAIS parameters and messaging data.

16. The method of claim 13, further comprising:
decoding the VAIS parameters and messaging data of the aircraft network to determine parameters available on the aircraft network and the simulation network at a given location and time, thereby configuring system-specific status information of an aircraft or the simulation network.

17. The method of claim 16, further comprising:
implementing the status logic via the processor, to evaluate the aircraft network and the simulation network, wherein the status logic includes using aircraft specific decision criteria to determine a status of the aircraft network and simulation network.

18. A computer-readable, non-transitory storage medium storing instructions that, when executed by a processor, cause the processor to perform a method by a configurable status console for an aircraft verification and integration system (VAIS) of an aircraft network of an aircraft, the method comprising:
performing an on-going scanning operation of the aircraft network and a simulation network in communication with the aircraft network;
retrieving data performance data, VAIS parameters and messaging data in real-time from the aircraft network and the simulation network, to determine the health of the aircraft; and
using status logic, analyzing the data and configuring a status of at least one of the aircraft or components or simulation thereof and generating a configured status for the at least one aircraft or components or simulation thereof to be displayed at the configurable status console.

19. The computer-readable, non-transitory storage medium of claim 18, wherein the retrieving further comprises continuously retrieving the performance data, the VAIS parameters and the message data in real-time from the aircraft network and the simulation network to determine the health of the aircraft.

20. The computer-readable, non-transitory storage medium of claim 17, wherein the method further comprises:
implementing the status logic via the processor, to evaluate the aircraft network and the simulation network, wherein the status logic includes using aircraft specific decision criteria to determine a status of the aircraft network and simulation network.
